(19) United States
(12) Patent Application Publication
(10) Pub. No.: US 2024/0329658 A1
(43) Pub. Date: Oct. 3, 2024

(54) SYSTEM AND METHOD OF GENERATING A FLIGHT PLAN FOR OPERATING AN AIRBORNE VEHICLE

(71) Applicant: UNITED STATES OF AMERICA AS REPRESENTED BY THE ADMINISTRATOR OF NASA, WASHINGTON, DC (US)

(72) Inventor: Truong X. Nguyen, POQUOSON, VA (US)

(21) Appl. No.: 18/617,802

(22) Filed: Mar. 27, 2024

Related U.S. Application Data
(60) Provisional application No. 63/455,691, filed on Mar. 30, 2023.

(51) Int. Cl. G05D 1/617; G05D 1/646

(52) U.S. Cl. CPC G05D 1/619; G05D 1/646

(57) ABSTRACT

A method of generating a flight plan for an airborne vehicle. The method includes identifying a region of operation of the airborne vehicle and identifying high-intensity radiated field (HIRF) sources associated with the region of operation of the airborne vehicle. A radiation tolerance level is obtained for the airborne vehicle for determining a HIRF stand-off zone for each of the HIRF sources based on the radiation tolerance level of the airborne vehicle and a potential radiated field generated by the HIRF source. The flight plan is generated for the airborne vehicle based on the HIRF stand-off zones within the region of operation.

### CROSS-REFERENCE TO RELATED PATENT APPLICATION(S)

This patent application claims the benefit of and priority to 63/455,691, filed on Mar. 30, 2023, the contents of which are hereby incorporated by reference in their entirety.

### STATEMENT REGARDING FEDERALLY SPONSORED RESEARCH OR DEVELOPMENT

The invention described herein was made by an employee of the United States Government and may be manufactured and used by or for the Government of the United States of America for governmental purposes without the payment of any royalties thereon or therefore.

### BACKGROUND OF THE INVENTION

Airborne vehicles can suffer from electromagnetic interference or even damage due to high-intensity radiated fields (HIRF) from high-power transmitters. The results can lead to the loss of vehicle functions or controls. The need to protect aircraft systems from HIRF has increased in recent years for many reasons, including greater dependency on digital electronics, reduced shielding in aircraft design, increased databus or processor speed, increased frequency spectrum usage, and the number of high-power transmitters.

HIRF sources include radars (e.g., weather, airport, ship, aircraft radars . . . ), terrestrial and satellite uplink transmitters, wireless phone towers, radio/TV towers, microwave links, and others. AM/FM/TV radio antennas can broadcast hundreds of thousand watts of radiated power. Radars, satellite uplinks, and microwave communication antennas can focus energy into intense narrow beams of significantly increased field intensity. Radio frequency (RF) threats also include cellular/wireless towers. User equipment such as cellular phones and portable two-way radios, due to their popularity and close proximity to airborne vehicle systems, could also pose an interference issue.

### BRIEF SUMMARY OF THE INVENTION

In accordance with an aspect of this disclosure, the present disclosure describes a system and method for generating a flight plan for an airborne vehicle. High-intensity radiated field (HIRF) sources are identified and the flight plan is generated based on a radiation tolerance level of the airborne vehicle and potential HIRF sources along the route.

In particular, an aspect of the present disclosure includes a method of generating a flight plan for an airborne vehicle. The method includes identifying a region of operation of the airborne vehicle and identifying high-intensity radiated field (HIRF) sources associated with the region of operation of the airborne vehicle. A radiation tolerance level is obtained for the airborne vehicle for determining a HIRF stand-off zone for each of the HIRF sources based on the radiation tolerance level of the airborne vehicle and a potential radiated field generated by the HIRF source. The flight plan is generated for the airborne vehicle based on the HIRF stand-off zones within the region of operation.

Also disclosed herein is a non-transitory computer-readable storage medium embodying programmed instructions which, when executed by a processor, are operable for performing the methods disclosed herein.

Also, disclosed herein is method of operating an airborne vehicle along a flight plan. The method includes identifying a region of operation of the airborne vehicle and identifying high-intensity radiated field (HIRF) sources associated with the region of operation of the airborne vehicle. A radiation tolerance level is obtained for the airborne vehicle for determining a HIRF stand-off zone for each of the HIRF sources based on the radiation tolerance level of the airborne vehicle and a potential radiated field generated by the HIRF source. The flight plan is generated for the airborne vehicle based on the HIRF stand-off zones within the region of operation and the airborne vehicle is directed along the flight plan.

Methods of claim 1 may involve identifying a region of operation of the airborne vehicle based on a predetermined distance from at least one of an origin location or a destination location for the airborne vehicle. A radiation tolerance level of the airborne vehicle may be selected based on an amount of navigable airspace within the region of operation for such airborne vehicle, relative to the HIRF sources. A radiation tolerance level for the airborne vehicle may be selected based on a quantity of HIRF sources within the region of operation and a radiation intensity of each of the HIRF sources within that region of operation. The HIRF stand-off zones may define a geographical space in the region of operation having a potential radiated field intensity that is equal to or greater than the radiation tolerance level of the airborne vehicle. In such case, the geographical space of the HIRF stand-off zone may be defined as a two-dimensional space in the region of operation. Optionally, the geographical space of the HIRF stand-off zone may be defined as a three-dimensional space in the region of operation. In some embodiments, determining the HIRF stand-off zone may include identifying a potential radiation intensity level and direction of radiation of the HIRF source and a direction of radiation of each of the HIRF sources. Generating a flight plan for the airborne vehicle based on the HIRF stand-off zone may include plotting a flight plan for the airborne vehicle that avoids intersecting the HIRF stand-off zones. Identifying the HIRF sources may include obtaining transmitter location and characteristics from government or regulatory databases.

These and other features, advantages, and objects of the present disclosure will be further understood and appreciated by those skilled in the art by reference to the following specification, claims, and appended drawings. The present disclosure is susceptible to various modifications and alternative forms, and some representative embodiments have been shown by way of example in the drawings and will be described in detail herein. It should be understood, however, that the novel aspects of this disclosure are not limited to the particular forms illustrated in the appended drawings. Rather, the disclosure is to cover all modifications, equivalents, combinations, sub combinations, permutations, groupings, and alternatives falling within the scope and spirit of the disclosure.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a schematic illustration of an example computer assembly.

FIG. 2 is an illustration of an example high-intensity radiated fields (HIRF) map.

FIG. 3 illustrates a method of generating a flight plan for an airborne vehicle.

### DETAILED DESCRIPTION OF THE INVENTION

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Typical airborne vehicles, such as aircraft and helicopters, are tested to required HIRF standards to ensure regulatory conformance. HIRF environments in these test standards are mostly dominated by transmitters located near large airports, where airborne vehicles are closest to the ground and are at the highest risk of being illuminated by a transmitter at a close distance. Aircraft HIRF standards were computed using typical aircraft flight paths at several representative airports in the US and Europe, along with considerations for military transmitters.

A helicopter's HIRF environment is more severe (i.e., higher field levels) than for other aircraft because helicopters generally operate closer to the ground in normal operation and can be directly illuminated by ground transmitters inside and outside of airport boundaries. The field strength can reach as high as 7200 V/m peak and 490 V/m average. In addition, helicopters may have much less metal shielding surfaces than other aircraft. HIRF protection of helicopter systems can be expensive due to high field exposure.

Advanced Air Mobility (AAM), Urban Air Mobility (UAM), and Unmanned Aircraft Systems (UAS) vehicles operate in similar HIRF environments as helicopters, as they fly close to the ground and can be illuminated directly by ground transmitters. It is expected that AAM, UAM, and UAS vehicles may be required to meet HIRF requirements for helicopters. Protection against severe HIRF environment could result in undesirable increased vehicle cost, size, and weight. Low-cost constructions with less shielding and filtering may make it difficult to pass in standard certification approach. Since UAM is a subset of AAM, both are referred to as AAM in this disclosure.

This disclosure is directed to lowering the costs of HIRF protection for airborne vehicles while maintaining a similar level of safety. One feature of this disclosure is to develop a HIRF map with a computer system 20 identifying sources of HIRF in a region of operation of the airborne vehicle. By identifying the sources of HIRF, these sources can be avoided during operation of the airborne vehicle, such that the airborne vehicle no longer needs to be designed to the worst-case HIRF environments associated with aircraft and helicopter standards because the airborne vehicles are restricted from being exposed to more severe HIRF environments than the airborne vehicle can safely tolerate. By avoiding HIRF transmitters by predetermine safe distances, HIRF tolerance for airborne vehicles could be achieved with reduced physical protection, leading to lower design and manufacturing costs.

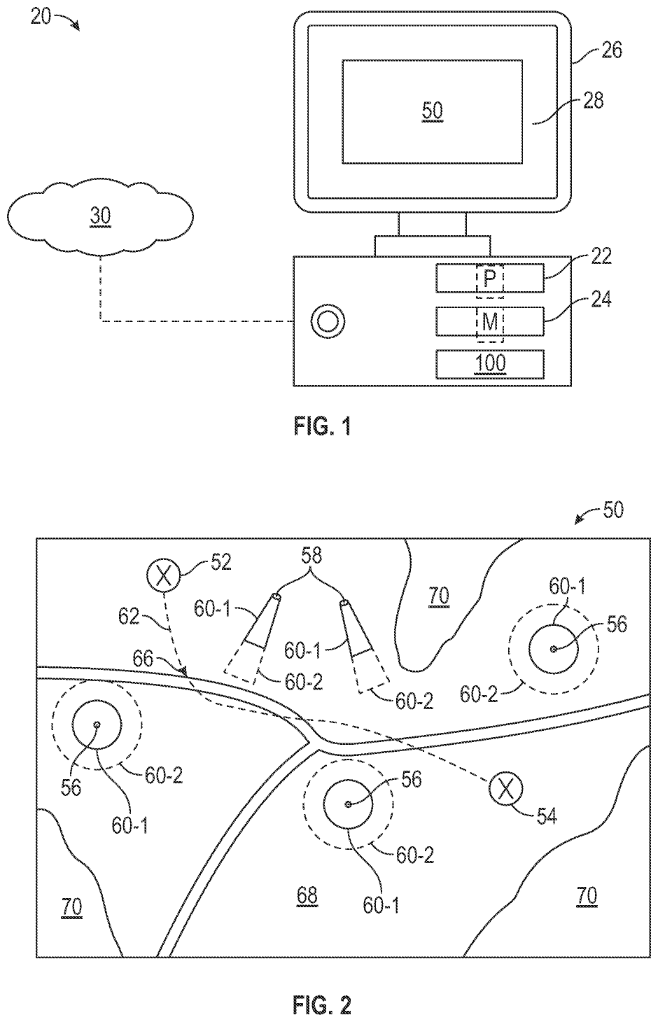

As discussed further below regarding the method 100, this disclosure employs knowledge of at least the transmitters' locations, radiation characteristics, and a radiation tolerance level for the airborne vehicle. One feature of this disclosure is to allow the radiation tolerance level for the airborne vehicle to be less than traditional radiation tolerance standards for helicopters and aircraft. The radiation tolerance levels for the airborne vehicles can be reduced by creating safe stand-off distances from HIRF transmitters by creating HIRF stand-off zones 60-1 and 60-2. Transmitter information regarding HIRF transmitters 56 and 58 can be obtained and used to calculate a size and a shape of the HIRF stand-off zones 60-1 60-2 based on airborne vehicle radiation tolerances as shown on a HIRF map 50 in FIG. 2 having a land region 68 and multiple bodies of water 70. The HIRF map 50 sets operational boundaries for the airborne vehicle based on its given radiation tolerance levels such that the airborne vehicle's radiation tolerance is not exceeded during operation along a flight path.

An example HIRF map 50 generated by the method 100 with the computer system 20 is shown in FIG. 2. The HIRF map 50 includes multiple HIRF transmitters 56 and 58. In the illustrated example, the HIRF transmitters 56 are illustrated as having circular HIRF stand-off zones 60-1 and 60-2 and the HIRF transmitters 58 are illustrated as having arc shaped HIRF stand-off zones 60-1 and 60-2.

The example computer system 20 of FIG. 1 is depicted as a unitary computer module for illustrative simplicity, the computer system 20 can be physically embodied as one or more processing nodes having the computer-readable storage medium (M) 24, i.e., application-sufficient memory, and associated hardware and software, such as but not limited to a high-speed clock, timer, input/output circuitry, buffer circuitry, and the like. The computer-readable storage medium 24 may include enough read only memory, for instance magnetic or optical memory. Computer-readable code or instructions embodying a method 100 described below may be executed during operation of the computer system 20. To that end, the computer system 20 may encompass one or more processors (P) 22, e.g., logic circuits, application-specific integrated circuits (ASICs), central processing units, microprocessors, and/or other requisite hardware as needed to provide the programmed functionality described herein. A display screen 26 may be connected to or in communication with the computer-readable storage medium 24 and processor(s) 22 to facilitate intuitive graphical presentation 28 of a flight plan for the airborne vehicle generated by the method 100 as described below.

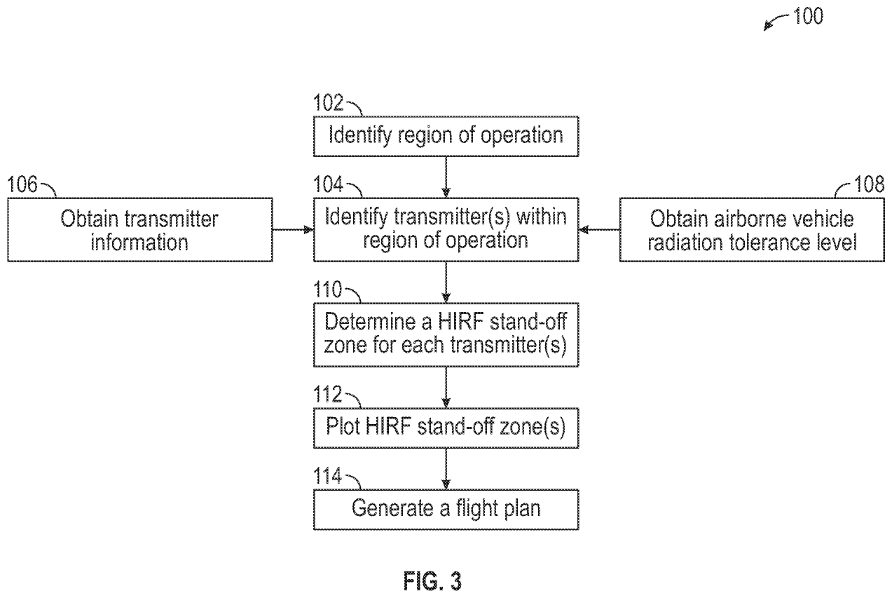

As shown in FIG. 3, the method 100 begins at Block 102 by determining or identifying a region of operation for the airborne vehicle 66. In one example, the method 100 determines or identifies the region of operation by identifying a geographical area where the airborne vehicle 66 could potentially operate between its origin location 52 and its destination location 54 (FIG. 2). This geographical area could include an area between an origin location corresponding to a location where the airborne vehicle 66 will depart for the flight plan and a destination location corresponding to a location where the airborne vehicle 66 will terminate the flight plan.

In one example, the region of operation could include a predetermined distance from the origin location 52 and the destination location 54. Additionally, depending on a potential distance between these two locations 52 and 54, the region of operation could also include a predetermined distance from a flight plan covering the shortest path or distance between these two locations. Once the region of operation has been identified, the method 100 proceeds to Block 104 to identify HIRF transmitters associated with the region of operation.

At Block 104, the method 100 begins identifying transmitter information in the region of operation identified in Block 102. The method 100 identifies transmitters in the region of operation by obtaining transmitter information from at least one database at Block 106. In one example, the transmitter information for the region of operation is obtained from databases available from government regulatory agencies that manage the implementation of HIRF transmitters. The transmitter information obtained from Block 106 can include a frequency spectrum, GPS location, power information, such as peak power and beam width or antenna gain, and modulation information, such as pulse width-max or continuous, for each of the transmitters in the region of operation.

The information from the government databases can be stored in the memory 24 of the computer system 20 or accessed online, such as through the internet through the cloud 30. This allows the transmitter information to be updated periodically or to be obtained directly from the government regulatory agency to ensure the accuracy of the information. While obtaining the transmitter information from regulatory agencies is disclosed as one possible example of obtaining transmitter information, the transmitter information can be obtained directly from other sources, such as cellular, radio, or television agencies, or a trusted private service provider.

Example government databases for obtaining the transmitter information can include databases maintained by the Federal Communications Commission (FCC). The FCC databases can be grouped into three systems: Consolidated Database System (CDBS), International Bureau Filing System (IBFS), and Universal Licensing System (ULS). However, FCC databases only report the spectrum licenses, not whether a transmitter is currently active. Therefore, the use of the FCC license databases creates a conservative identification of HIRF transmitters because not all of the licensed transmitters are active at a given time.

The CDBS contains information on AM, FM, and TV broadcast services. The information from CDBS may also be obtained from the Licensing and Management System (LMS) which is replacing the CDBS. However, transmitter information from CDBS includes GPS location data for many transmitters that are rounded to the nearest second. This can result in antenna locations being approximated by up to 98.4 feet (30 meters). This possible variation can be taken into consideration when determining the HIRF stand-off zone for each of the transmitters as discussed further below in Block 110. However, more accurate transmitter locations may be obtained from commercially available satellite imagery.

Furthermore, for map purposes, power data given in Effective Radiated Power (FM and TV) or field strength (at a given distance) (AM) are first converted to Equivalent Isotropic Radiated Power (EIRP) before calculating safe distance R in Eq. 1 below. Data for the highest field direction is used to ensure conservative calculation.

If the airborne vehicle 66 encounters transmitters from CDBS of between 30 MHZ and 0.1 GHZ, an example radiation tolerance level of at least 55 V/m may provide sufficient protection for this disclosure. If the airborne vehicle 66 encounters transmitters from CDBS of between 0.1 GHz and 0.4 GHz, an example radiation tolerance level of at least 105 V/m may provide sufficient protection for this disclosure. If the airborne vehicle 66 encounters transmitters from CDBS that are between 0.4 GHz and 1 GHz, an example radiation tolerance level of at least 105-200 V/m is recommended for the airborne vehicle 66 to control the size of the avoidance zones, and a HIRF map is then used to avoid those zones. In all cases, a minimum of 100 feet separation between the transmitter and the airborne vehicle 66 is assumed, per HIRF standard.

IBFS contains international and satellite applications and licenses. The information from the IBFS may also be obtained from the International Communications Filing System (ICFS) which is replacing the IBFS. Relevant to this disclosure are satellite earth-stations transmitters. While the actual radiated power is not nearly as high as TV transmitters, antennas can have high gains and narrow beam widths (2 degrees or less typically), resulting in EIRP that can exceed 90 dBwatts (or 1 billion watts). Like the CDBS database, GPS location data for many locations are truncated to the nearest second so location uncertainty needs to be accounted for in flight planning and defining HIRF stand-off zones.

Therefore, to be conservative, calculations from the IBFS database assume the worst case if data are not provided. If antenna elevation angle data are specified, the HIRF stand-off zone radius is scaled down by multiplying with the cosine of the elevation angle to convert a radius in three-dimensional space when plotting on a two-dimensional map and not a three-dimensional map. If angular data are provided, the HIRF stand-off zones become smaller fan-shaped zones representing possible scanning ranges of the transmitters as shown by transmitters 58 in FIG. 2. Otherwise, zero-degree antenna elevation angle and 360-degree azimuth steering range are utilized for this disclosure while a 180-degree azimuth steering range is also possible for antennas tracking satellites in or near the equatorial orbits.

For IBFS systems operating between 4 GHz and 8 GHz, an example radiation tolerance of at least 500 V/m is recommended to control the size of HIRF avoidance zones, but the level may not provide sufficient protection to 100 feet distance from some transmitters. The use of HIRF map to evade the HIRF avoidance zone can provide the sufficient protection.

ULS contains consolidated databases for many services. The relevant services may include land mobile radio (broadcast auxiliary, commercial, and private), maritime coast & aviation ground, microwave, paging, broadband radio service (BRS) & education broadband service (EBS), market-based services, and cellular. Radiation characteristics, such as antenna beamwidth, direction, and height, may be utilized in determining HIRF stand-off zones if the data are provided, such as in microwave transmitters.

If the airborne vehicle 66 encounters transmitters from ULS that are either less than 2 GHZ or between 2 GHz and 40 GHz, an example radiation tolerance level of 25 V/m or 50 V/m, respectively, for the airborne vehicle 66 may provide sufficient protection with this disclosure without the use of HIRF Map. A minimum separation distance of 100 feet from transmitters is assumed per standard.

Another example database for obtaining transmitter information includes weather radars from the National Oceanic and Atmospheric Administration (NOAA). The weather radars include Terminal Doppler Weather Radar (TDWR) and Next-Generation Weather Radar (NEXRAD). These radars are assumed to have 360-degree azimuth rotation and zero-degree elevation angle with an estimated radiated power of approximately 25 billion watts EIRP.

If the airborne vehicle 66 encounters transmitters from NOAA that are either peak or average, an example radiation tolerance level of 1000 V/m or 50 V/m, respectively, is recommended. This level is far below the current standard and could represent significant vehicle HIRF protection cost saving. HIRF Map according to the present approach may be used to provide avoidance zones.

Other example databases for consideration for obtaining transmitter information include the National Telecommunications and Information Administration (NTIA) and the Federal Aviation Administration (FAA). The NTIA manages the spectrum used by the US federal government, including the military. The FAA maintains databases of transmitters at and near airports for supporting safe airspace operation.

Information regarding airport locations and boundaries, helipad locations, and military installation boundaries can also be obtained and utilized to generate the HIRF map 50, as discussed below due to their relevance for flight planning as including areas to be avoided. Also, included are the FAA's UAS facility maps that show the maximum altitudes around airports where FAA may authorize some drone operations without additional safety analysis.

Block 104 of the method 100 also obtains a radiation tolerance level for the airborne vehicles 66 from Block 108. In one example, the airborne vehicle radiation tolerance levels obtained from Block 108 can be determined through physical or simulated testing of the airborne vehicle 66. This testing provides a level of radiation tolerance used to determine the HIRF stand-off zones 60-1, 60-2 for the HIRF map 50 of FIG. 2 as described in greater detail below. The tolerance level can include a collection of peak and average field strength tolerance levels for different frequency segments from 10 kHz to 40 GHz. The frequency segments division should match the frequency segments of the FAA rotorcraft HIRF environment standard.

When choosing an airborne vehicle's design parameters, selecting a greater radiation tolerance level increases the navigable airspace for the airborne vehicle 66 while potentially increasing its weight, complexity, or cost due to the increase in shielding needed. Conversely, selecting a lower radiation tolerance level reduces the navigable airspace for the airborne vehicle 66 while potentially reducing its weight, complexity, or cost due to the reduction in shielding needed. The radiation tolerance level for the airborne vehicle 66 can also be selected and designed for based on a quantity of HIRF transmitters T within the region of operation and a radiation intensity of each of the HIRF transmitters within the region of operation. The radiation tolerance level for the airborne vehicle 66 may vary with frequency, such that the radiation tolerance level should correspond with the frequency and power of transmitters that the airborne vehicle 66 expects to encounter as determined from the HIRF map 50.

With the information collected from Blocks 102, 106, and 108, the method 100 can proceed to Block 110 to determine the HIRF stand-off zone for each of the HIRF transmitters 56, 58 based on a given airborne vehicle 66.

One feature or aspect of determining the HIRF stand-off zones 60-1, 60-2 at Block 110 is that the zones provide a safe distance that is far enough from the transmitters 56, 58 so that its signal strength falls below the airborne vehicle's radiation tolerance level. The radiation tolerance level should correspond with the frequency and modulation of the transmitter 56, 58. This allows a flight plan to be generated that will avoid exposing the airborne vehicle to a radiation level that exceeds its tolerance level. The stand-off distance based on the airborne vehicles radiation tolerance level can be calculated with EQ. 1 and EQ. 2 below.

In EQ. 1, E_{T} is the airborne vehicle radiation tolerance level in Volts/meter (V/m) at the frequency of the transmitter. The value for E_{T} can be calculated from testing performed on the airborne vehicle 66 or it can be selected arbitrarily as a value less than the given standard to determine its influence on the navigable airspace within the region of operation. It may be selected based on an amount of navigable airspace within the region of operation for the airborne vehicle 66, relative to the HIRF sources. This value can then be used as a target for designing the shielding of the airborne vehicle 66. P_{T} EQ. 1 is the HIRF transmitter's equivalent isotropic radiated power (EIRP), in watts. Setting the vehicle tolerance's equivalent power density (computed from E_{T}) to be greater than the power density from the HIRF source at distance R, then solve for R. This operation results in R, the minimum safe distance from the transmitter 56, 58. The transmitter information may also indicate that the distance R only applies to a limit arc relative to the location of the transmitter due to the direction of transmission.

$$\frac{{P}_{T}}{4 π {R}^{2}} < \frac{{E}_{T}^{2}}{377} \qquad EQ . 1$$

$$R > \frac{{( 30 * {P}_{T} )}^{1 / 2}}{{E}_{T}} \qquad EQ . 2$$

The HIRF stand-off zone can then identify a region inside the radius R from the transmitter that would exceed the radiation tolerance level of the airborne vehicle 66. This region is at higher risk of interference and is highlighted for avoidance when generating the flight plan. Regions outside of radius R are considered to have lower interference risk for operation of the airborne vehicle 66. Accordingly, each HIRF stand-off zone defines a geographical space in the region of operation having a potential radiated field intensity that is equal to or greater than the radiation tolerance of the airborne vehicle 66. Additionally, the geographical space of the HIRF stand-off zone can be defined as a two-dimensional space or a three-dimensional space in the region of operation.

At Block 112, the HIRF stand-off zones are overlaid onto a map of the region of operation, such as a commercial map, to generate the HIRF map 50 of FIG. 2. The HIRF map 50 identifies the navigable airspace for the airborne vehicle 66 in the region of operation based on its given radiation tolerance level. As shown in FIG. 2, the HIRF map 50 includes a first set of stand-off zones 60-1 (solid lines) that correspond to the airborne vehicle 66 having a first radiation tolerance level and a second set of stand-off zones 60-2 (dashed lines) that correspond to the airborne vehicle 66 with a second radiation tolerance level that is less than the first radiation tolerance level. These stand-off zones 60-1, 60-2 illustrate how the navigable space in the region of operation varies based on radiation tolerance and a frequency of the transmitters 56, 58. With at least one set of stand-off zones 60-1, 60-2 provided in the HIRF map 50, the method 100 can proceed to Block 114.

At Block 114, the method 100 generates a flight plan 62 for the airborne vehicle 66 based on the HIRF stand-off zones within the region of operation. The flight plan provides a proposed path of operation for the airborne vehicle 66 to follow that will avoid exposure to radiation more than its radiation tolerance level, for example, avoiding intersecting the HIRF stand-off zones. The method 100 can also direct the airborne vehicle 66 to operate along the flight path defined by the flight plan.

While aspects of the present disclosure have been described in detail with reference to the illustrated embodiments, those skilled in the art, now having the benefit of the present disclosure, will recognize that many modifications may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and sub combinations of the preceding elements and features.

What is claimed is:

1. A method of generating a flight plan for an airborne vehicle, the method comprising:
identifying a region of operation of the airborne vehicle;
identifying high-intensity radiated field (HIRF) sources associated with the region of operation of the airborne vehicle;
obtaining a radiation tolerance level for the airborne vehicle;
determining a HIRF stand-off zone for each of the HIRF sources based on the radiation tolerance level of the airborne vehicle and a potential radiated field generated by the HIRF source; and
generating the flight plan for the airborne vehicle based on the HIRF stand-off zones within the region of operation.

2. The method of claim 1, wherein the region of operation of the airborne vehicle is identified based on a predetermined distance from at least one of an origin location or a destination location for the airborne vehicle.

3. The method of claim 1, wherein the radiation tolerance level of the airborne vehicle is selected based on an amount of navigable airspace within the region of operation for the airborne vehicle relative to the HIRF sources.

4. The method of claim 1, wherein the radiation tolerance level for the airborne vehicle is selected based on a quantity of HIRF sources within the region of operation and a radiation intensity of each of the HIRF sources within the region of operation.

5. The method of claim 1, wherein each HIRF stand-off zone defines a geographical space in the region of operation having a potential radiated field intensity that is equal to or greater than the radiation tolerance level of the airborne vehicle.

6. The method of claim 5, wherein the geographical space of the HIRF stand-off zone is defined as a two-dimensional space in the region of operation.

7. The method of claim 6, wherein the geographical space of the HIRF stand-off zone is defined as a three-dimensional space in the region of operation.

8. The method of claim 1, wherein determining the HIRF stand-off zone includes identifying a potential radiation intensity level and direction of radiation of the HIRF source and a direction of radiation of each of the HIRF sources.

9. The method of claim 1, wherein generating the flight plan for the airborne vehicle based on the HIRF stand-off zone includes plotting a flight plan for the airborne vehicle that avoids intersecting the HIRF stand-off zones.

10. The method of claim 1, wherein identifying the HIRF sources includes obtaining transmitter location and characteristics from regulatory databases.

11. A non-transitory computer-readable storage medium embodying programmed instructions which, when executed by a processor, are operable for performing a method comprising:
identifying a region of operation of an airborne vehicle;
identifying high-intensity radiated field (HIRF) sources associated with the region of operation of the airborne vehicle;
obtaining a radiation tolerance level for the airborne vehicle;
determining a HIRF stand-off zone for each of the HIRF sources based on the radiation tolerance level of the airborne vehicle and a potential radiated field generated by the HIRF source; and
generating a flight plan for the airborne vehicle based on the HIRF stand-off zones within the region of operation.

12. The computer-readable storage medium of claim 11, including directing the airborne vehicle to operate along a flight path defined by the flight plan.

13. The computer-readable storage medium of claim 11, wherein the region of operation of the airborne vehicle is identified based on predetermined distance from at least one of an origin location or a destination location for the airborne vehicle.

14. The computer-readable storage medium of claim 11, wherein the radiation tolerance level of the airborne vehicle is selected based on an amount of navigable airspace within the region of operation for the airborne vehicle relative to the HIRF sources.

15. The computer-readable storage medium of claim 11, wherein each HIRF stand-off zone defines a geographical space in the region of operation having a potential radiated field intensity that is equal to or greater than the radiation tolerance level of the airborne vehicle.

16. The computer-readable storage medium of claim 11, wherein generating the flight plan for the airborne vehicle based on the HIRF stand-off zone includes plotting a flight plan for the airborne vehicle that avoids intersecting the HIRF stand-off zones.

17. The computer-readable storage medium of claim 11, wherein identifying the HIRF sources includes obtaining transmitter location and characteristics from regulatory databases.

18. The computer-readable storage medium of claim 11, wherein determining the HIRF stand-off zone includes identifying a potential radiation intensity level and direction of radiation of the HIRF source and a direction of radiation of each of the HIRF sources.

19. The computer-readable storage medium of claim 11, wherein identifying the HIRF sources includes obtaining transmitter location and characteristics from regulatory databases.

20. A method of operating an airborne vehicle along a flight plan, the method comprising:
identifying a region of operation of the airborne vehicle;
identifying high-intensity radiated field (HIRF) sources associated with the region of operation of the airborne vehicle;
obtaining a radiation tolerance level for the airborne vehicle;
determining a HIRF stand-off zone for each of the HIRF sources based on the radiation tolerance level of the airborne vehicle and a potential radiated field generated by the HIRF source;
generating the flight plan for the airborne vehicle based on the HIRF stand-off zones within the region of operation; and
directing the airborne vehicle to operate along a flight path defined by the flight plan.
